(19) United States
(12) Patent Application Publication
(10) Pub. No.: US 2012/0069511 A1
(43) Pub. Date: Mar. 22, 2012

(54) DATA STORAGE UNIT HAVING CLASPING FEATURE

(76) Inventor: PAULE S. AZERA, San Diego, CA (US)

(21) Appl. No.: 13/069,227

(22) Filed: Mar. 22, 2011

Related U.S. Application Data
(60) Provisional application No. 61/316,315, filed on Mar. 22, 2010.

(51) Int. Cl. G06F 1/16; A44C 5/00

(52) U.S. Cl. 361/679.03; 63/1.14

(57) ABSTRACT

An electronic data storage unit configured to be worn as a bracelet is disclosed herein. In a preferring embodiment, medical records are recorded to a USB flash memory device that is deployed in various ways and is integrated to jewelry design. Also in a preferred embodiment, a bracelet design is provided to a storage compartment that could carry other small items in addition to the memory device. Further, novel clasping structure is provided by the present invention.

### PRIORITY CLAIM

This patent application contains subject matter claiming benefit of the priority date of U.S. Provisional Patent Application Ser. No. 61/316,315 filed on Mar. 22, 2010 and entitled, DATA STORAGE UNIT HAVING CLASPING FEATURE, accordingly, the entire contents of this provisional patent application is hereby expressly incorporated by reference.

### BACKGROUND OF THE INVENTION

1. Field of the Invention

The present invention pertains generally removable storage media. More particularly, in a preferred embodiment, the present invention relates to a USB data storage device having decorative elements, such as those found in jewelry, and further having a clasping feature.

2. Description of the Prior Art

The observation known as Moore's Law in the area of computer hardware projects that the number of transistors that can be inexpensively etched to a semiconductor doubles about every two years. Therefore recently, removable storage devices have reduced enough in actual size so that a reasonable amount of storage capacity can be carried by a user wherever they travel without being overly cumbersome. Also recently, individuals in the medical field have brought fourth designs for portable storage devices that contain a personal medical history and other information. One such proposal was made by Hasvold in U.S. Pat. App. Pub. No. 2008/0291744, entitled “Portable Medical Storage Device And Program.”

As told by Hasvold, medical records are normally stored at individual's doctor's offices or hospitals in either hard copy or electronic files. Most patients see more than one doctor or are admitted to more than one hospital in their lifetimes. Presently, there is no communication between individual doctor's offices or hospitals enabling a patient's medical records to be compiled into one comprehensive group either in hard copy or electronic format. There is further no ability for a new doctor treating a patient to see a complete set of new patient medical records. There is a great need for all of a patient's medical records from each doctor to be compiled and stored in one central location. A complete set of each patient's medical records would enable doctors and hospitals to provide better and more complete care to individuals and would reduce the amount of misdiagnosis or inaccurate prescriptions.

Additionally, first responders and emergency room physicians would greatly benefit from easily accessible and relevant patient medical information. Also, elderly patients and those with complicated medical and pharmaceutical histories can greatly benefit from portable storage of medical information.

In light of the above, it is an object of the present invention to combine decorative elements such as those found in jewelry to a storage device further having clasping features incorporated thereto. It is a further object of the present invention to provide a USB (Universal Serial Bus) connection incorporated to a clasp of a bracelet or a necklace. It is still an additional objective of the present invention to provide electronic heath information portably for individual and family, in addition to any other financial or other records that could be useful in emergency situations.

### BRIEF SUMMARY OF THE INVENTION

The present invention specifically addresses and alleviates the above mentioned deficiencies associated with the prior art. More particularly, the present invention in a first aspect, the present invention is an electronic storage device, for portably providing storage of digital files to a user, the device comprising: a first half enclosure housing having a digital memory chip there within; a USB connection electronically coupled to the digital memory chip and protruding from the first half enclosure housing; a second half enclosure housing removably coupled to the first half, the second half enclosure providing housing to the USB connection when the device is in the stored position; and a bracelet portion coupled to the first half enclosure housing, the bracelet portion providing portability thereof to the user.

The invention in this aspect is additionally characterized in the bracelet portion comprises material chosen from a group consisting of metal, leather, plastic, leather, cloth, and hemp. Also with regard to the bracelet portion, the first half enclosure housing is coupled thereto via a first extension coupled to the first half enclosure, the first extension further coupled a fixed ring which is coupled to the bracelet portion of the device, providing portability thereof to the user.

Further to the electronic storage device in this aspect a first latch on a first lateral side of the first half enclosure housing is provided, extending to the second half enclosure housing. Similarly, an opposing latch is provided on an opposing lateral side of the second half enclosure extending to the first half enclosure housing, the first and opposing latch providing a removable connection to the device.

In a second aspect, the invention may be characterized as a bracelet for providing portable storage of digital information comprising: a first curved rail; a second curved rail opposite the first curved rail; a fixed axis of rotation configured between and perpendicular to the first and second curved rail; and a first door hinge rotatable coupled to the fixed axis of rotation, the first door hinge having a USB flash memory device configured thereto.

The invention in this aspect may be additionally characterized wherein the first door hinge and the USB flash memory device configuration comprises a relief in the first door hinge; and a thumb protrusion coupled to the USB flash memory device, the thumb protrusion configured to inside the relief, the thumb protrusion for slidingly deploying the USB flash memory device. Alternatively, the first door hinge could provide access to a first storage compartment, as described in other embodiments herein.

Also, the invention in the second aspect further comprises a second door hinge wherein the first door hinge connects to the fixed axis of rotation at a mid-point thereof and wherein the second door hinge connects to the fixed axis of rotation on opposite sides of the mid-point, the second door hinge having a second USB device configured thereto. Still further, the first curved rail is characterized as comprising an eyelet at an end thereof, the eyelet coupled to a bracelet portion wherein the eyelet and the curved rail are a contiguous piece. Also to this embodiment, the first rail is coupled to a first bracelet portion and the second rail is coupled to a second bracelet portion, the first and second bracelet portions forming parallel loops.

In still a third aspect, the invention may be characterized as a bracelet for providing portable storage to relatively small items comprising: a circular band; a rectangular storage compartment configured to the band, a storage compartment door hingedly coupled to the rectangular storage compartment, the storage compartment door providing access to the storage compartment.

The bracelet in this aspect is additionally characterized in that the circular band further has a break cut out thereof, the break further having opposing ends, the opposing ends each having a cylindrical groove carved out thereof. Further, the storage compartment comprises cylindrical protrusions configured to be removably received by the opposing ends each having the cylindrical groove carved out thereof. In alternative embodiments, the compartment door comprises a rectangular shape or that of an isosceles trapezoid.

These, as well as other advantages of the present invention will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a perspective illustration of a first preferred embodiment of the present invention;

FIG. 1B is a top plan view thereof;

FIG. 1C provides a profile view;

FIG. 1D is a perspective view of the first embodiment unclasped to reveal a USB connection;

FIG. 1E is a perspective illustration of the first preferred embodiment in use;

FIG. 2A is a top plan view of a second preferred embodiment;

FIG. 2B is a top plan view thereof;

FIG. 2C provides a profile view;

FIG. 2D is a perspective view of a second preferred embodiment of the present invention;

FIG. 2E and FIG. 2F illustrate a digital storage device being deployed;

FIG. 3A is a perspective illustration of yet another invention embodiment;

FIG. 3B is a top plan view thereof;

FIG. 3C is a profile view this bracelet embodiment;

FIG. 3D is an enlarged view of the area defined by line 3B in FIG. 3C.

FIG. 3E is an additional perspective view of the invention embodiment shown having a compartment in an open position;

FIG. 3F is an additional top plan view showing an alternative compartment door design;

FIG. 4A is a perspective view of yet another bracelet embodiment of the present invention similar to that shown in FIG. 1A through FIG. 1E;

FIG. 4B is a top plan view thereof;

FIG. 4C provides a profile view;

FIG. 4D is a perspective view of the first embodiment unclasped to reveal a USB connection;

FIG. 5A is a top plan view of yet another invention embodiment is a perspective view of yet still another bracelet embodiment of the present invention;

FIG. 5B is a profile view thereof;

FIG. 5C and FIG. 5D provide perspective view of the invention embodiment in use; and

FIG. 6A and FIG. 6B are perspective illustrations of yet a sixth embodiment of the present invention.

### DETAILED DESCRIPTION OF PREFERRED EMBODIMENTS

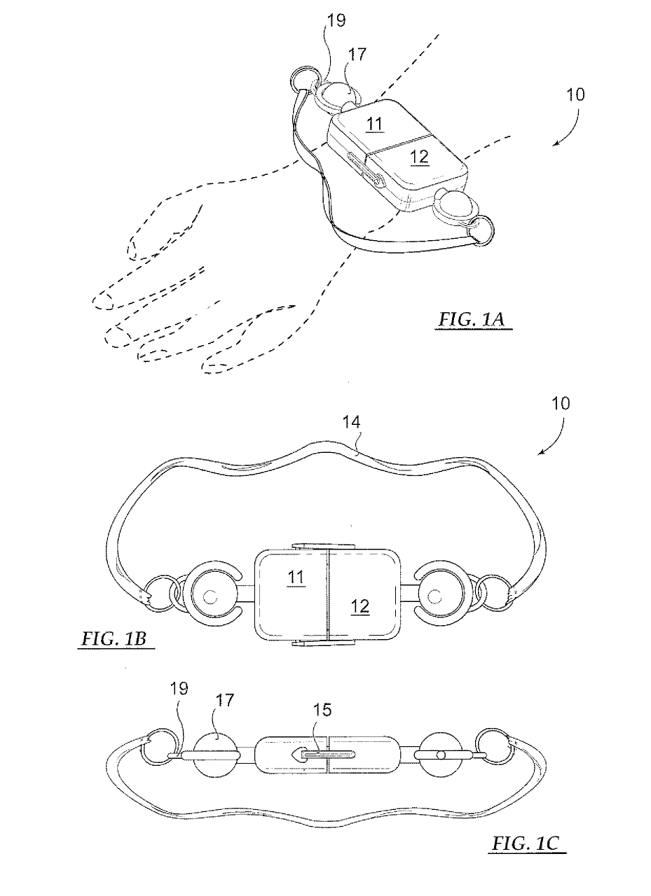

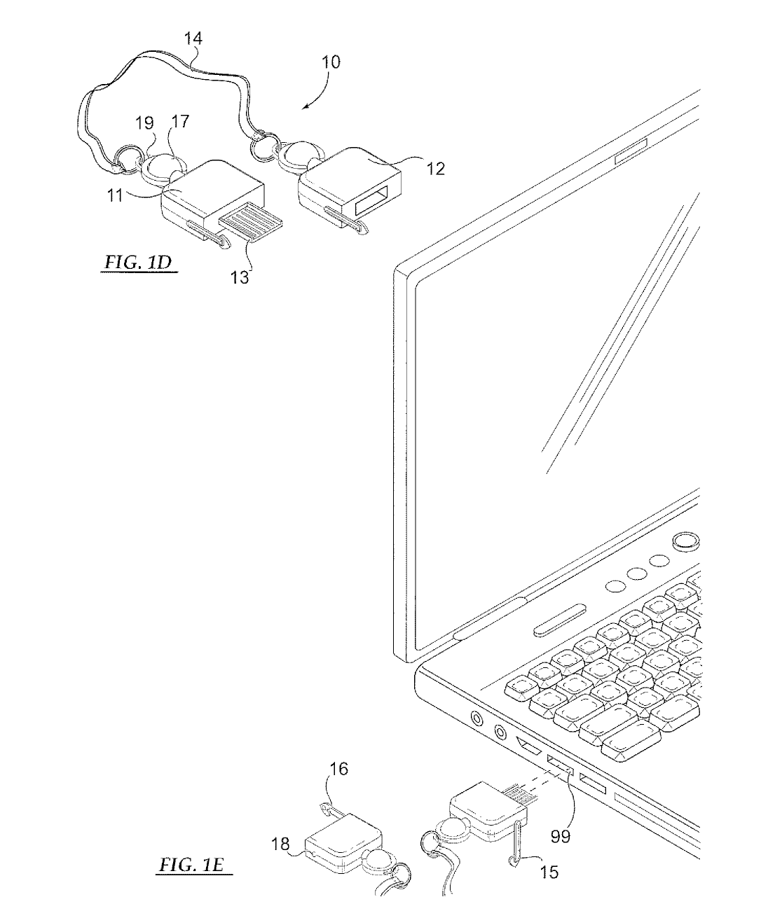

With reference to FIG. 1A through FIG. 1C, a first preferred device 10 of the present invention is illustrated in perspective. Generally, the device forms part of a bracelet 10 wherein two ends 11, 12 mate together. A union where the two ends 11, 12 mate together is part of a clasping feature; and additionally the clasping feature is also a housing 11, 12 for a USB connection 13 coupled to a digital storage medium (housed within first half enclosure housing 11). As shown in FIG. 1D, a first end comprises the USB connection 13 along with a storage medium. A second half enclosure houses the USB connection 13 when clasp 15, 16 is engaged. Each of the first and second ends contains an arm 15, 16 that is able to latch one end to the other via a snap 18 connection . The arms 15, 16 can additionally rotate out of the way (FIG. 1E) for when the USB connection 13 is coupled to a computer device USB port 99. The storage medium could comprise data including health information for individual and family, in additional to any financial or other records that could be useful in emergency situations.

Optionally, the USB and storage portions 13 could slide out of the housing 11, 12 (bracelet first/second end), and therefore, there would be no need to make the arms 15, 16 rotatable. One advantage to this option is that many storage devices could be swapped out of any particular bracelet 10.

Further with regard to FIG. 1A through FIG. 1E, a ball joint 17 is provided coupling first 11 and second 12 enclosures further connected to an eyelet 19. The ball joint 17 further comprises ball and socket portions, the ball fixed to each of the first and second ends 11, 12; and the socket fixed to corresponding eyelets 19. Additionally, the eyelets 19 are coupled to structure 14 that will form the rest of the bracelet or necklace (or the like). In an alternative embodiment, the housing 11, 12 and ball joints 17 are comprised of biodegradable material.

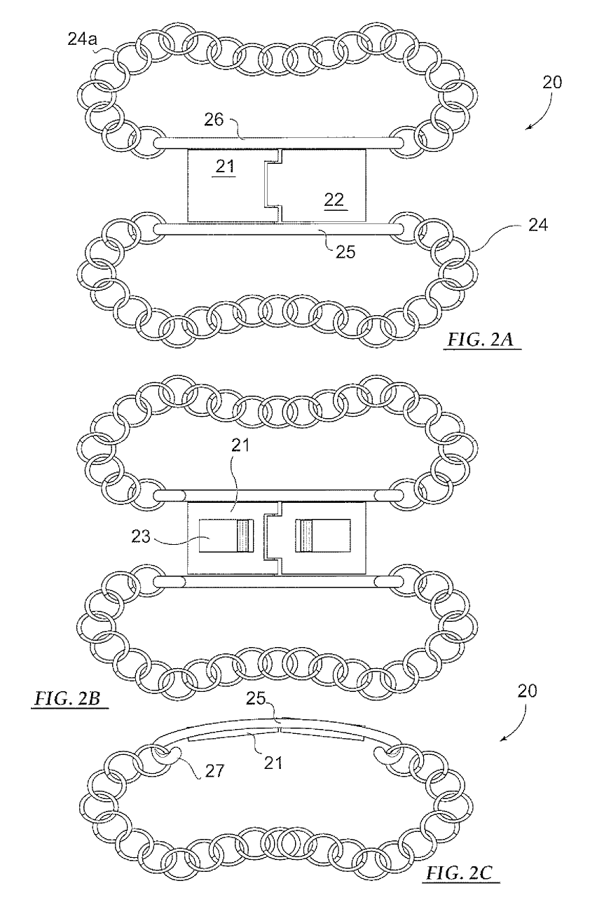

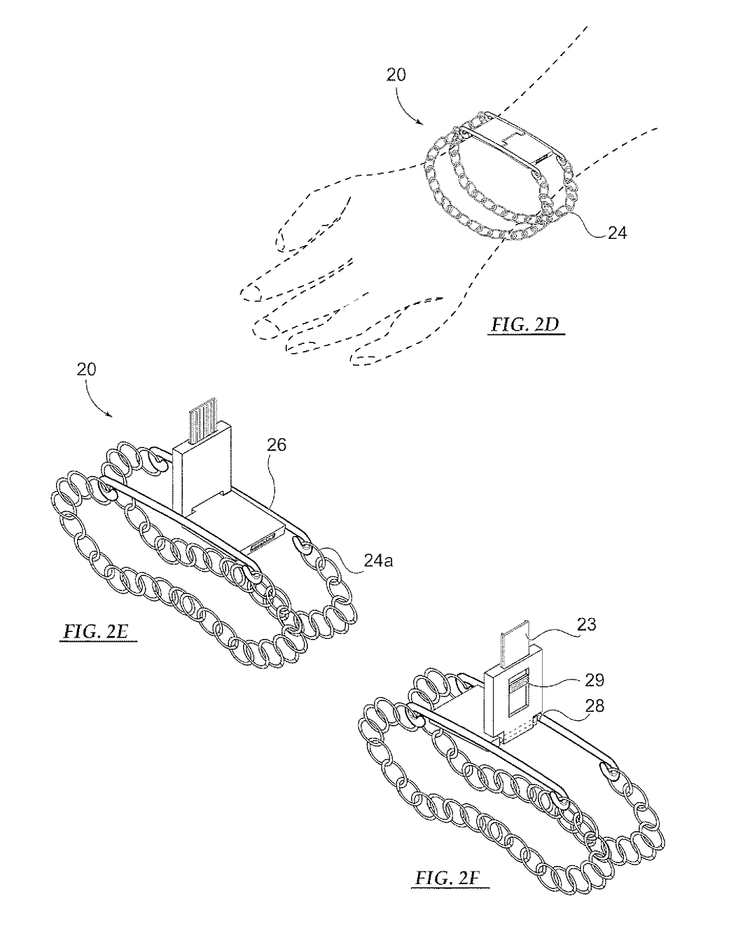

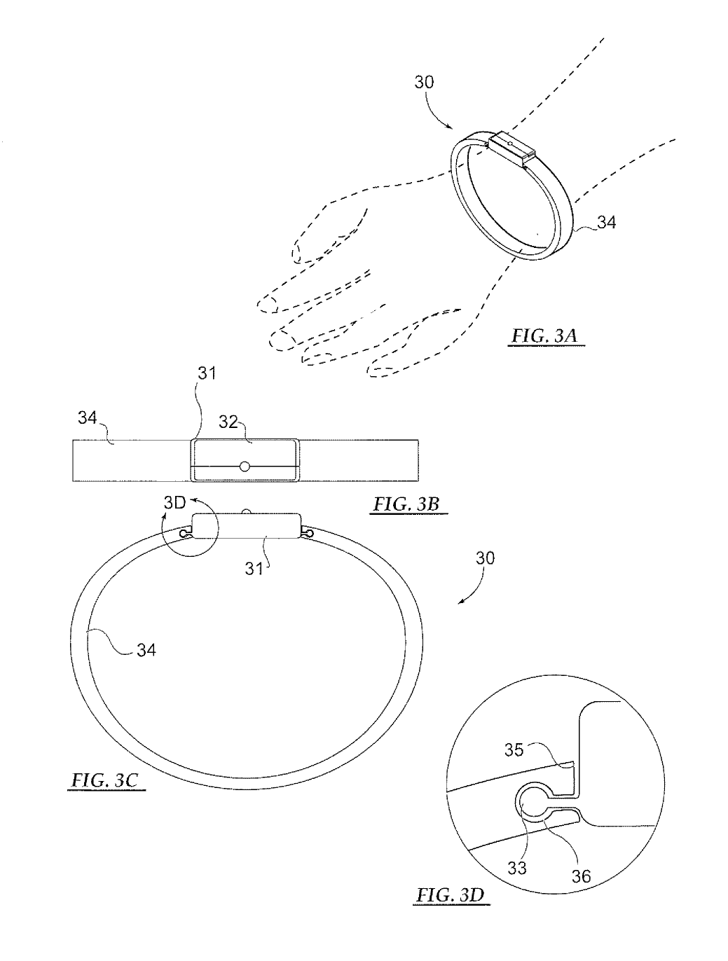

With regard to FIG. 2A through FIG. 2F, a second preferred embodiment is disclosed herein comprising a metallic bracelet/data storage unit 20. Alternatively, the metallic bracelet is polarized/ionized so that it can help discharge bioelectric ions that may be the result of anxiety, malnutrition or some other type of exposure or stress to the body. Also alternatively, the bracelet 20 may be magnetized to take advantage of purported health benefits of magnetotherapy. As shown, the bracelet comprises first 21, 22 and second door hinges having a cover rotating about a common fixed rotational axis 28 (FIG. 2F). The second door hinge 22 engages the axis at a mid-section; while the first door hinge engages the hinge on opposite sides of the mid-section. Further, the door hinges 21, 22 are flanked by to metallic bars 25, 26 that are curved and generally in a shape of a user's wrist.

As stated, in this particular embodiment 20, the invention comprises a first curved rail 25, a second curved rail 26 opposite the first curved rail 25, a fixed axis of rotation 28 configured between and perpendicular to the first 25 and second curved rail 26. A first door hinge 21 is provided rotatably coupled to the fixed axis of rotation 28. The first door hinge 21 further has a USB flash memory device 23 configured thereto. As best shown in FIG. 2F, the first door hinge 21 has a relief wherein a thumb protrusion 29 coupled to the USB flash memory device can be accessed. The thumb protrusion 29 is for slidingly deploying the USB flash memory device 23. Alternatively, the first door hinge 21 could provide access to a first storage compartment (e.g. 31), as described in other embodiments 30 herein.

Additionally, the curved rails 25, 26 are characterized as comprising an eyelet 27 at an end thereof, the eyelet coupled to bracelet portions 24, 24a wherein the eyelet 27 and the curved rail are a contiguous piece 25. Also to this embodiment, the first 24 and second 24a bracelet portions form parallel loops.

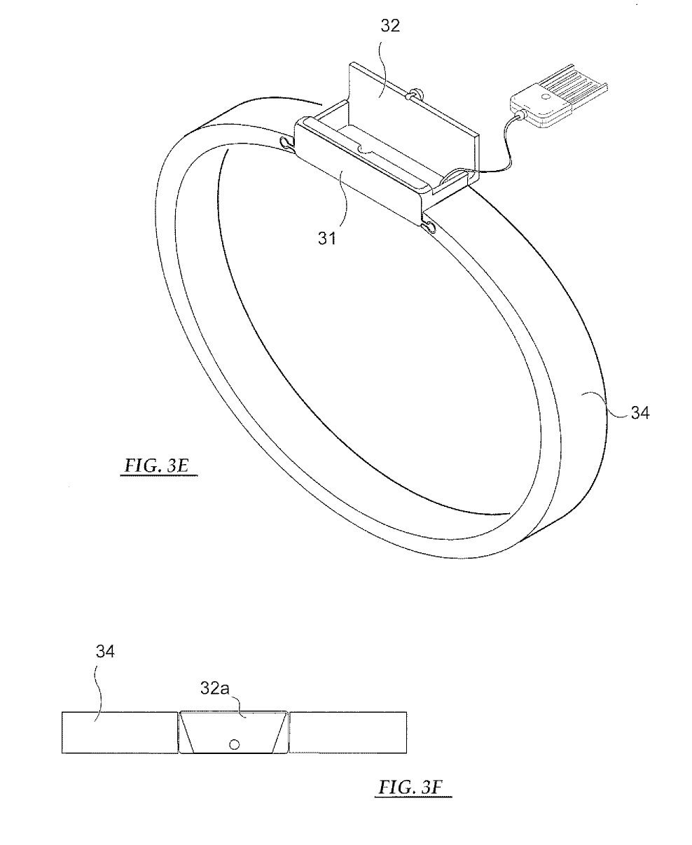

With reference to FIG. 3A through FIG. 3D, an additional embodiment 30 is illustrated in perspective and various other views. As shown, the bracelet 30 comprises a continuous smooth surface having a break 35 cut out of the circular bracelet 30. Further, two cylindrical channels 36 are carved out of ends 35 of the break. A storage compartment 31 is configured to fit inside of the break 35. In a preferred embodiment, the storage compartment 31 is rectangular in shape and is configured to store an electronic storage medium with a USB connector further as illustrated in FIG. 3E. The compartment 31 additionally comprises a compartment door 31 that is rectangular in shape in a preferred embodiment. Alternatively, the compartment door could be shaped like an envelope flap or an isosceles trapezoid such as illustrated in FIG. 3F.

Further with regard to FIG. 3C, the break 35 has opposing ends each having a cylindrical groove 36 carved out thereof. The storage compartment 31 has cylindrical protrusions 36 that are further configured to be slidingly received by the opposing cylindrical grooves 33. The bracelet 30 could further be comprised of plastic material or even polymer magnetic material.

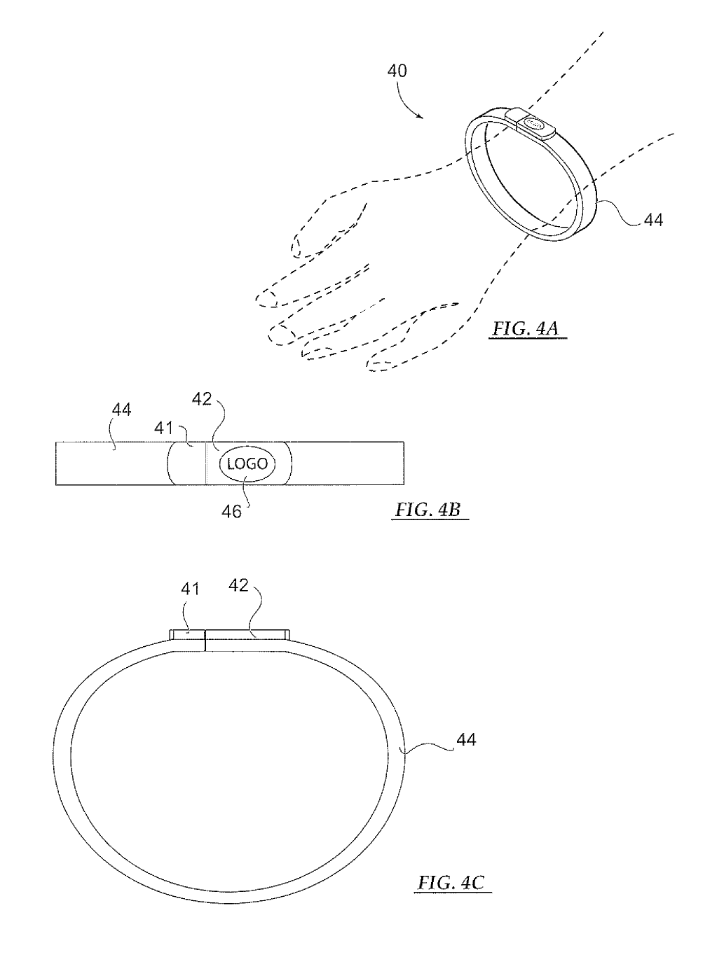

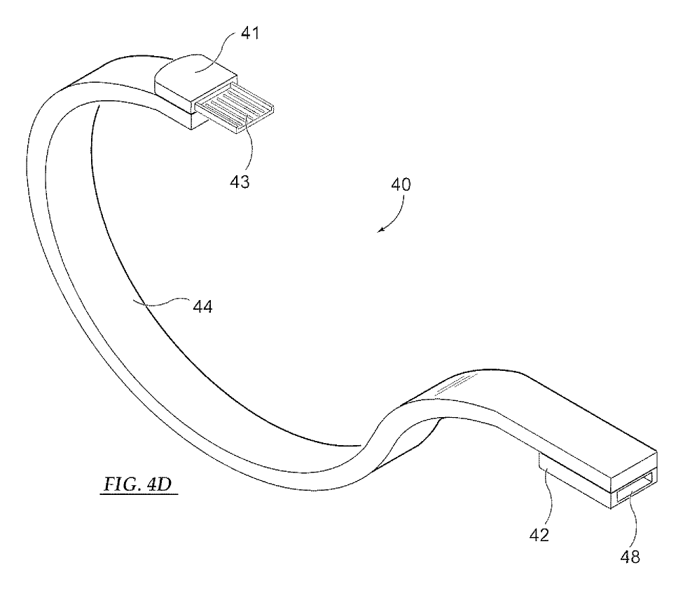

FIG. 4A through FIG. 4D illustrates an additional embodiment 40 similar to that illustrated in the FIG. 1A through FIG. 1E wherein a bracelet 44 is configured with a thicker portion 41, 42 that houses an electronic storage device with a USB connection 43. A logo 46 is provided to the thicker portion 41, 42 having first 41 and second 42 enclosure housings.

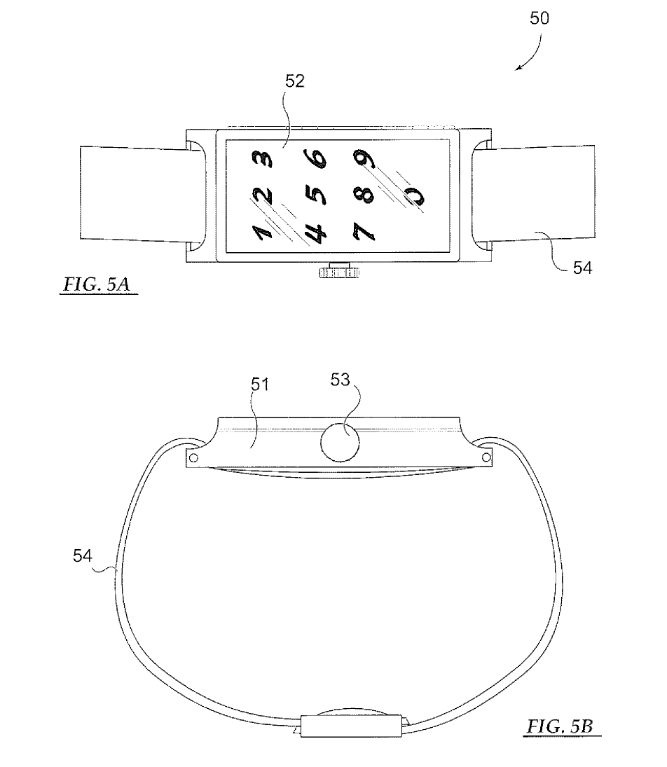

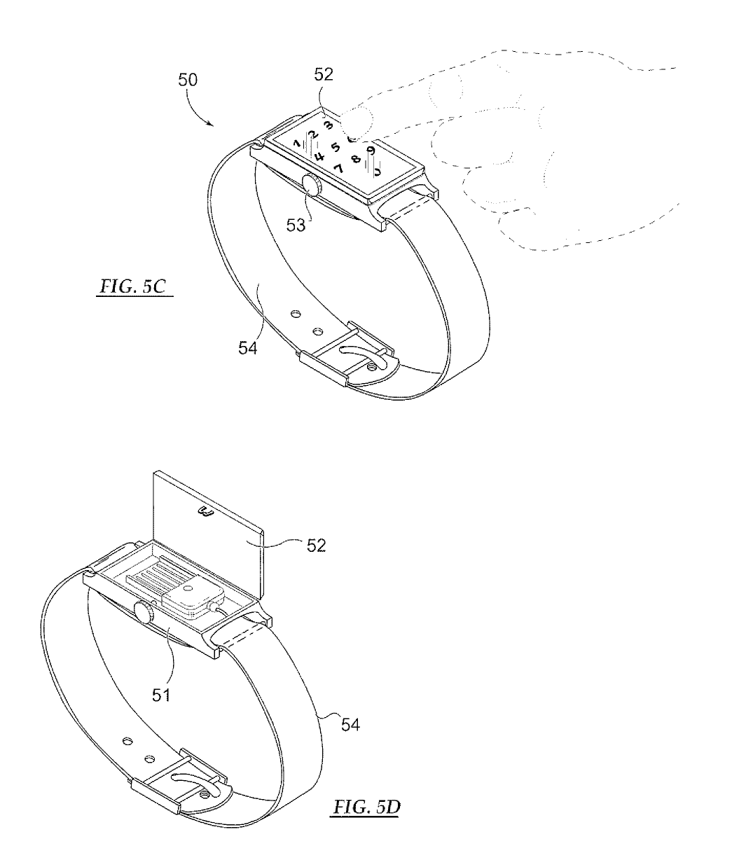

FIG. 5A through FIG. 5D illustrate an additional invention embodiment 50 intended to resemble a watch face 52 coupled to a watch band 54. However, the watch face 52 actually provides a combination lock to a secure latch 53. Storage compartment 51 could house a USB device as in other embodiments or another small item.

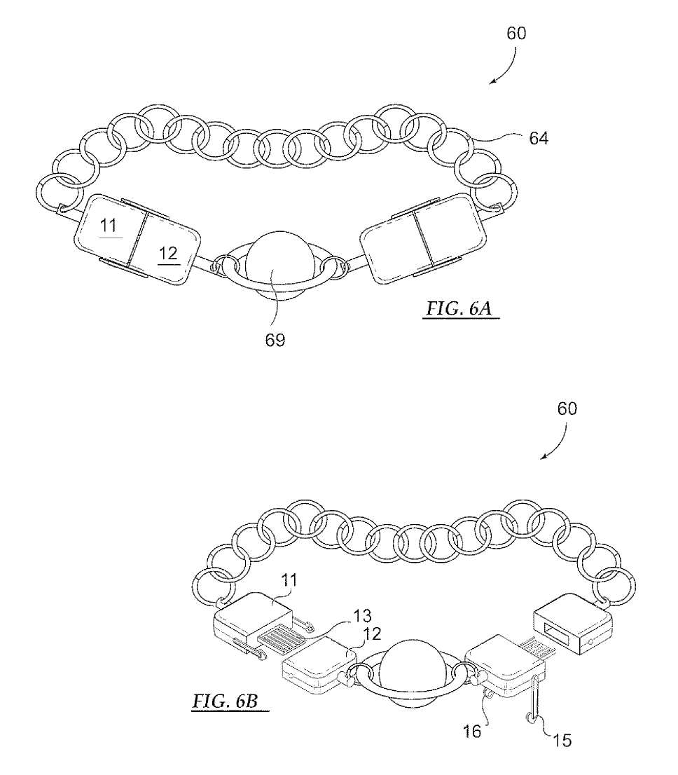

FIG. 6A and FIG. 6B illustrate an additional embodiment 60 in perspective wherein multiple storage devices 13 may be configured to the same bracelet portion 64. Similar to the FIG. 1A through FIG. 1E embodiment 10, first 11 and second 12 housing enclosures are initially provided with latches 15, 16. These are connected to similar structure via a ball and ring connection 69 providing functionality in addition to a visually pleasing jewelry piece 60.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Data Storage Unit Having Clasping Feature as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. An electronic storage device, for portably providing storage of digital files to a user, the device comprising:
a first half enclosure housing having a digital memory chip there within;
a USB connection electronically coupled to the digital memory chip and protruding from the first half enclosure housing;
a second half enclosure housing removably coupled to the first half, the second half enclosure providing housing to the USB connection when the device is in the stored position; and
a bracelet portion coupled to the first half enclosure housing, the bracelet portion providing portability thereof to the user.

2. The electronic storage device of claim 1, the bracelet portion comprising material chosen from a group consisting of metal, leather, plastic, leather, cloth, and hemp.

3. The electronic storage device of claim 1, wherein the bracelet portion is coupled to the first half enclosure housing via a first extension coupled to the first half enclosure, the first extension further coupled to the bracelet portion of the device, providing portability thereof to the user.

4. The electronic storage device of claim 3 wherein the first extension comprises a ball and socket joint.

5. The electronic storage device of claim 1, the digital memory chip comprising medical information.

6. The electronic storage device of claim 1 further comprising:
a first latch on a first lateral side of the first half enclosure housing extending to the second half enclosure housing; and
an opposing latch on an opposing lateral side of the second half enclosure extending to the first half enclosure housing, the first and opposing latch providing a removable connection to the device.

7. A bracelet for providing portable storage of digital information comprising:
a first curved rail;
a second curved rail opposite the first curved rail;
a fixed axis of rotation configured between and perpendicular to the first and second curved rail; and
a first door hinge rotatable coupled to the fixed axis of rotation, the first door hinge having a USB flash memory device configured thereto.

8. The bracelet of claim 7, wherein the first door hinge having the USB flash memory device configured thereto comprises:
a relief in the first door hinge;
a thumb protrusion coupled to the USB flash memory device, the thumb protrusion configured to inside the relief, the thumb protrusion for slidingly deploying the USB flash memory device.

9. The bracelet of claim 7, further comprising a second door hinge wherein the first door hinge connects to the fixed axis of rotation at a mid-point thereof and wherein the second door hinge connects to the fixed axis of rotation on opposite sides of the mid-point, the second door hinge having a second USB device configured thererto.

10. The bracelet of claim 7, the first curved rail comprising an eyelet at an end thereof, the eyelet coupled to a bracelet portion wherein the eyelet and the curved rail are a contiguous piece.

11. The bracelet of claim 7 wherein the first rail is coupled to a first bracelet portion and the second rail is coupled to a second bracelet portion storage, the first and second bracelet portions forming parallel loops.

12. A bracelet for providing portable storage to relatively small items comprising:
a circular band;
a rectangular storage compartment configured to the band,
a storage compartment door hingedly coupled to the rectangular storage compartment, the storage compartment door providing access to the storage compartment.

13. The bracelet of claim 12, the circular band further comprising a break cut out thereof, the break further having opposing ends, the opposing ends each having a cylindrical groove carved out thereof.

14. The bracelet of claim 12, the storage compartment comprising cylindrical protrusions configured to be removeably received by the opposing ends each having the cylindrical groove carved out thereof.

15. The bracelet of claim 12, the compartment door comprising a rectangular shape.

16. The bracelet of claim 12, the compartment door comprising an isosceles trapezoidal shape.
